(19) United States
(12) Patent Application Publication
(10) Pub. No.: US 2026/0014858 A1
(43) Pub. Date: Jan. 15, 2026

(54) ACCESSORY CONTROL SYSTEM

(71) Applicant: Isuzu Motors Limited, Yokohama-shi (JP)

(72) Inventor: Yuya HAGIHARA, Fujisawa-shi (JP)

(73) Assignee: Isuzu Motors Limited, Yokohama-shi (JP)

(21) Appl. No.: 19/262,181

(22) Filed: Jul. 8, 2025

(30) Foreign Application Priority Data
Jul. 9, 2024 (JP) 2024-110433

(51) Int. Cl. B60K 35/10; B60K 35/20; B60W 40/02; B60W 50/08

(52) U.S. Cl. CPC B60K 35/10; B60K 35/20; B60W 40/02; B60W 50/08

(57) ABSTRACT

The accessory control system of the present disclosure includes: a vehicle state determining section that determines a state of a vehicle; a vehicle-surrounding-safety monitoring section that monitors safety in surroundings of the vehicle; a remote instruction receiving section that receives, from an external apparatus, instruction information for operating an accessory; an accessory control section that performs control of an operation of the accessory based on a determination result of the vehicle state determining section, a monitoring result obtained by the vehicle-surrounding-safety monitoring section, and the instruction information received by the remote instruction receiving section; and an accessory driving section that drives the accessory based on the control by the accessory control section.

### CROSS REFERENCE TO RELATED APPLICATIONS

This application claims the benefit of priority of Japanese Patent Application No. 2024-110433, filed on Jul. 9, 2024, the contents of which are incorporated by reference as if fully set forth herein in their entirety.

### TECHNICAL FIELD

The present disclosure relates to an accessory control system that controls an accessory provided in a vehicle.

### BACKGROUND ART

There are vehicles called specially-equipped vehicles provided with an accessory. Examples of the specially-equipped vehicles include: a wing truck including, as an accessory, wings which open and close; a dump truck including, as an accessory, a bed which is raised and lowered; a concrete mixer truck including, as an accessory, a drum for mixing ready-mixed concrete; and a concrete pump truck including, as an accessory, a concrete pumping section.

As described in Patent Literature (hereinafter referred to as “PTL”) 1 or the like, a specially-equipped vehicle is provided with an operation section for operating an accessory. The operation section is constituted by a lever(s), a button(s), and/or the like, and is operated by the driver and/or a worker on site.

### CITATION LIST

### Patent Literature

### PTL 1

Japanese Patent Application Laid-Open No. 2023-090282

### SUMMARY OF INVENTION

### Technical Problem

By the way, in recent years, the transportation industry has a problem with a labor shortage of drivers or the like. To address this problem, it has been proposed to operate trucks in an unmanned manner by using autonomous driving technology.

However, the automation for accessories has not been discussed sufficiently, which poses an obstacle to solving the labor shortage as the problem in the transportation industry.

The present disclosure has been made in view of the above points, and provides an accessory control system capable of performing automatic control of an accessory safely.

### Solution to Problem

One aspect of an accessory control system of the present disclosure is an accessory control system that controls an accessory installed in a vehicle, and includes:
a vehicle state determining section that determines a state of the vehicle;
a vehicle-surrounding-safety monitoring section that monitors safety in surroundings of the vehicle;
a remote instruction receiving section that receives, from an external apparatus, instruction information for operating the accessory;
an accessory control section that performs control of an operation of the accessory based on a determination result of the vehicle state determining section, a monitoring result obtained by the vehicle-surrounding-safety monitoring section, and the instruction information received by the remote instruction receiving section; and
an accessory driving section that drives the accessory based on the control by the accessory control section.

### Advantageous Effects of Invention

According to the present disclosure, it is possible to realize an accessory control system capable of performing automatic control of an accessory safely.

### BRIEF DESCRIPTION OF DRAWINGS

FIG. 1 is a block diagram illustrating a configuration of a vehicle according to an embodiment;

FIG. 2 is a diagram illustrating a wing truck;

FIG. 3 is a diagram illustrating a dump truck;

FIG. 4 is a diagram illustrating a concrete mixer truck;

FIG. 5 is a diagram illustrating a concrete pump truck; and

FIG. 6 is a diagram provided for describing reservation information.

### DESCRIPTION OF EMBODIMENTS

Hereinafter, an embodiment of the present disclosure will be described with reference to the accompanying drawings.

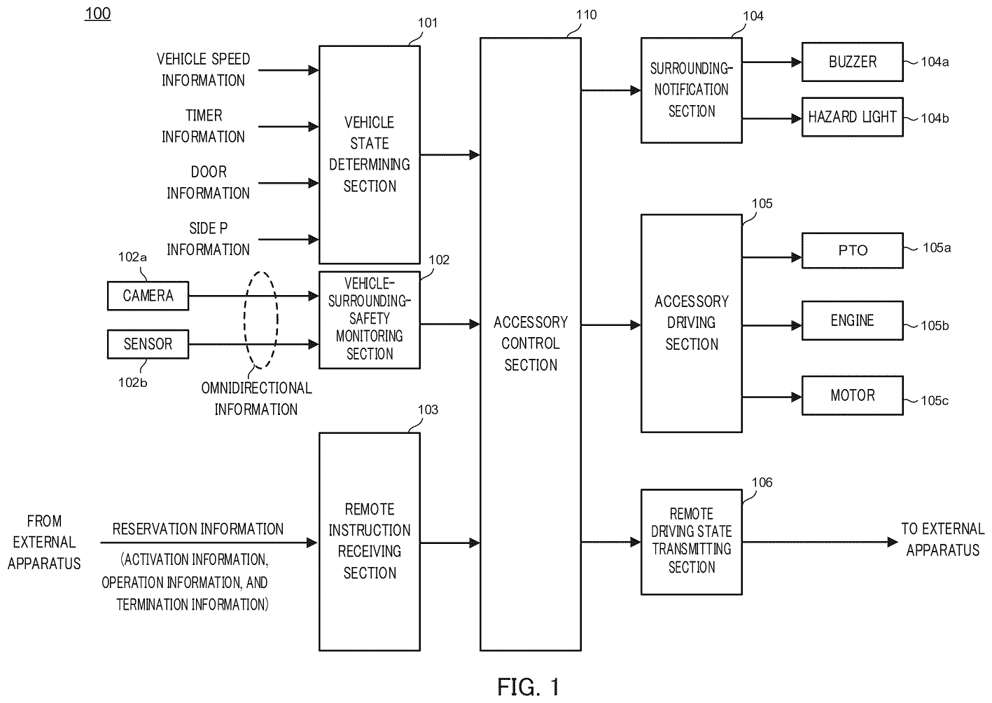

FIG. 1 is a block diagram illustrating a configuration of vehicle 100 according to an embodiment of the present disclosure. Vehicle 100 is a so-called specially-equipped vehicle including an accessory.

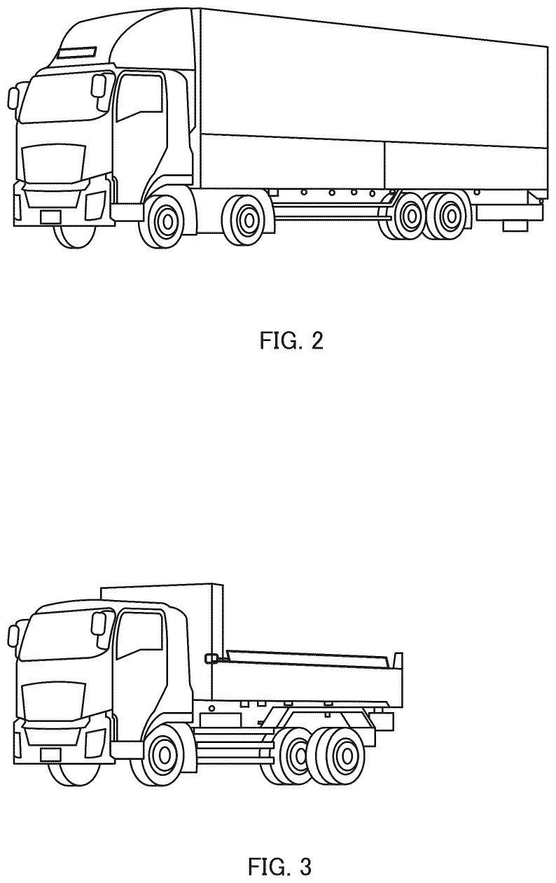

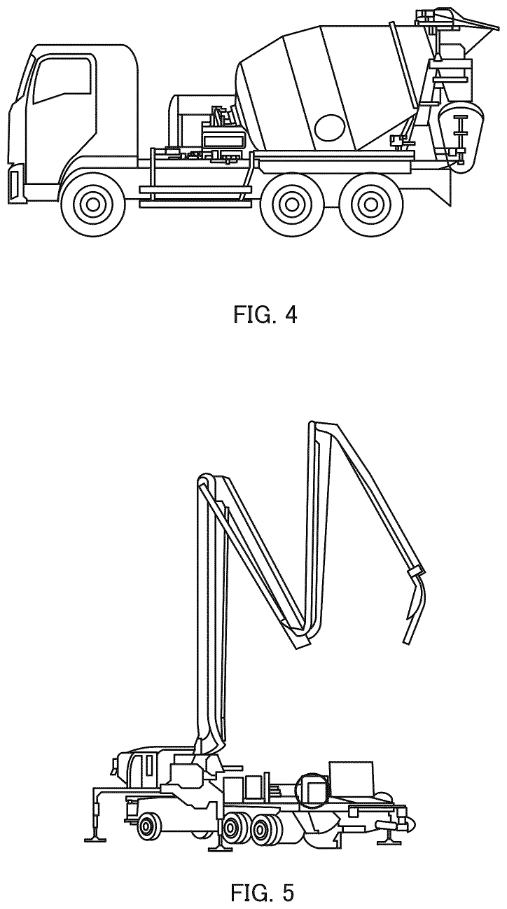

FIGS. 2 to 5 illustrate examples of the specially-equipped vehicle to which the present embodiment is directed. FIG. 2 illustrates a wing truck including, as an accessory, wings which open and close, FIG. 3 illustrates a dump truck including, as an accessory, a bed which is raised and lowered, FIG. 4 illustrates a concrete mixer truck including, as an accessory, a drum for mixing ready-mixed concrete, and FIG. 5 illustrates a concrete pump truck including, as an accessory, a concrete pumping section.

Note that, vehicle 100 may be a specially-equipped vehicle other than those exemplified in FIGS. 2 to 5, and the point is that it is satisfactory when vehicle 100 includes an accessory.

Vehicle 100 includes vehicle state determining section 101, vehicle-surrounding-safety monitoring section 102, remote instruction receiving section 103, surrounding-notification section 104, accessory driving section 105, remote driving state transmitting section 106, and accessory control section 110.

Vehicle state determining section 101 receives inputs of vehicle speed information, timer information, door information, side parking (side P) information, and/or the like, and determines based on these pieces of information whether vehicle 100 is in the parked state. Vehicle state determining section 101 determines that vehicle 100 is in the parked state, for example, in a case where one minute or longer has elapsed since the vehicle speed has become 0 km/h, all the doors are closed, and the side parking operates.

Vehicle-surrounding-safety monitoring section 102 receives inputs of pieces of omnidirectional information from camera 102a and sensor 102b and monitors, based on these pieces of information, safety in the surroundings of vehicle 100. Specifically, by using camera 102a for capturing an image of the surroundings of the vehicle and sensor 102b for detecting an object in the surroundings of the vehicle, vehicle-surrounding-safety monitoring section 102 determines that it is safe to operate the accessory in a case where camera 102a and sensor 102b detect no object such as a human in an accessory operation region of vehicle 100. Vehicle-surrounding-safety monitoring section 102 determines, on the other hand, that it is not safe to operate the accessory in a case where camera 102a and sensor 102b detect an object such as a human in the accessory operation region of vehicle 100.

Remote instruction receiving section 103 receives instruction information for operating the accessory from an external apparatus. Here, the external apparatus is a center apparatus that transmits instruction information for controlling a plurality of vehicles 100 including the accessory to each of the plurality of vehicles 100, and transmits, as instruction information for operating the accessory reservation, information including date and time information for operating the accessory to each of the plurality of vehicles 100. The center apparatus is, for example, a server apparatus operated by a transportation company.

In an example of the present embodiment, the reservation information includes activation information, operation information, and termination information. The activation information is information for instructing the activation of engine 105b or motor 105c, or the like, which is the torque-generating source for power take off (PTO) 105a. The operation information is information for operating PTO 105a, instructing the forward or reverse rotation of PTO 105a, and instructing how to operate the accessory. That is, the operation information is information for instructing the operation mode of the accessory. The termination information is information for instructing the stop of PTO 105a and the stop of engine 105b, motor 105c, or the like, which is the torque-generating source for PTO 105a.

Note that, the reservation information is information in which the activation information, the operation information, and the termination information as described above are indicated in a schedule format. Specifically, the reservation information is information including the date and time of activation, the date and time of operation, and the date and time of termination. This reservation information will be described in detail later.

When the accessory is driven and controlled by accessory control section 110, surrounding-notification section 104 calls the attention of a person in the surroundings of vehicle 100, by using buzzer 104a and hazard warning light (hazard light) 104b, or the like, that the accessory is driven. Note that, the attention calling by surrounding-notification section 104 is not necessarily performed during the driving of the accessory, but may be performed from a predetermined time before the accessory is driven. Further, the attention calling is not necessarily performed by using buzzer 104a and hazard warning light (hazard light) 104b, but may be performed by using, for example, a display or the like.

Accessory driving section 105 drives portions for operating the accessory, such as PTO 105a, engine 105b, and motor 105c, based on a control signal from accessory control section 110.

Remote driving state transmitting section 106 transmits the driving state of the accessory to the external apparatus (center apparatus) based on a signal from accessory control section 110. Further, remote driving state transmitting section 106 also transmits vehicle state information (including, for example, vehicle speed information, door information, and side parking (side P) information) or surrounding monitor information (including, for example, omnidirectional information) to the external apparatus (center apparatus).

Accessory control section 110 performs control of an operation of the accessory based on a determination result of vehicle state determining section 101, a monitoring result obtained by vehicle-surrounding-safety monitoring section 102, and instruction information received by remote instruction receiving section 103.

Accessory control section 110 includes a central processing unit (CPU), a random access memory (RAM), a read only memory (ROM), and the like as the main components. The CPU reads a program according to a processing content from the ROM, develops the program in the RAM, and cooperates with the developed program to control surrounding-notification section 104, accessory driving section 105, and remote driving state transmitting section 106 based on the outputs of vehicle state determining section 101, vehicle-surrounding-safety monitoring section 102, and remote instruction receiving section 103. Note that, accessory control section 110 may be formed entirely or partially of a hard-wired circuit such as an application specific integrated circuit (ASIC) and a field-programmable gate array (FPGA).

The control by accessory control section 110 will be described specifically. In a case where a determination result indicating that vehicle 100 is in the parked state is obtained by vehicle state determining section 101 and a monitoring result indicating that there is nobody in the operation region of the accessory is obtained by vehicle-surrounding-safety monitoring section 102, accessory control section 110 decides that the driving of the accessory indicated by the instruction information is performed. In other words, even when it is instructed by the instruction information that the accessory is driven, accessory control section 110 decides that the accessory is not driven in a case where vehicle 100 is not in the parked state or in a case where there is a person in the surroundings of vehicle 100.

Note that, the driving of the accessory here means that the accessory is actually operated. In the present embodiment, accessory control section 110 causes the activation to be performed before the operation to cause the engine and/or the motor to be operated, and causes accessory driving section 105 to actually operate the accessory after confirming that there is nobody in the operation region of the accessory.

When accessory control section 110 decides that the accessory is operated, accessory control section 110 outputs a control signal for operating the accessory to accessory driving section 105, and causes surrounding-notification section 104 and remote driving state transmitting section 106 to perform the aforementioned attention calling for the surroundings and to perform the aforementioned operation to notify the external apparatus (center apparatus) of the remote driving state.

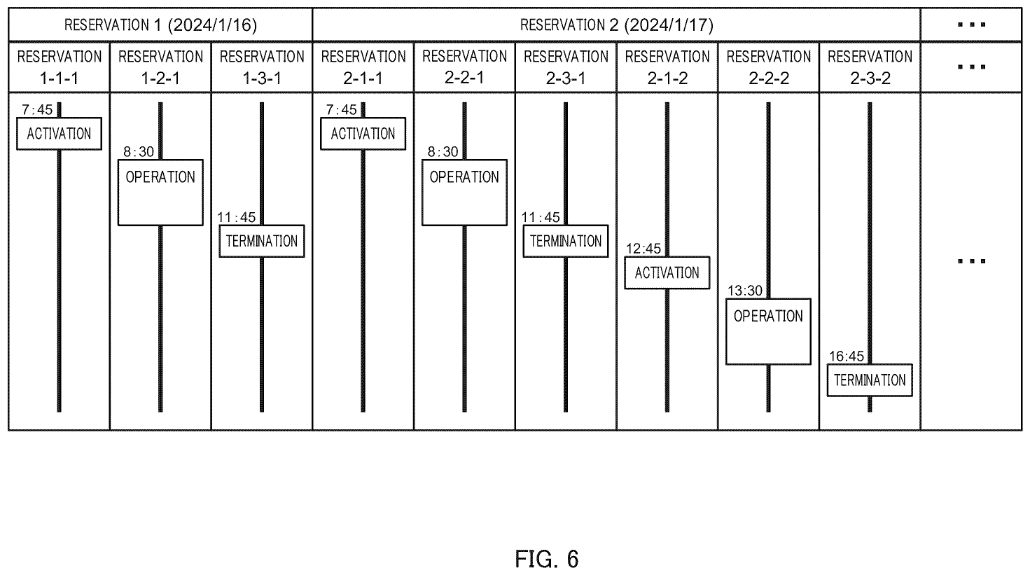

FIG. 6 is a diagram provided for describing reservation information that is transmitted from the external apparatus (center apparatus) and received by remote instruction receiving section 103.

As can be seen from the diagram, the reservation information includes information on the date and time of activation, information on the date and time of operation, and information on the date and time of termination. In the example of FIG. 6, reservation information for instructing that the engine or the motor, or the like is activated at 7:45 on Jan. 16, 2024, the accessory is operated from 8:30, and the engine or the motor, or the like, is stopped at 11:45 is transmitted from the external apparatus (center apparatus). In addition, reservation information for instructing that the engine or the motor, or the like is activated at 7:45 on Jan. 17, 2024, the accessory is operated from 8:30, and the engine or the motor, or the like, is stopped at 11:45 is transmitted from the external apparatus (center apparatus). Further, reservation information for instructing that the engine or the motor, or the like is activated at 12:45 on Jan. 17, 2024, the accessory is operated from 13:30, and the engine or the motor, or the like, is stopped at 16:45 is transmitted from the external apparatus (center apparatus).

In the data structure of the reservation information, for example, data of the date and time of reservation is placed in a first data region, data of the operation type (for example, 1: activation, 2: operation, and 3: termination) is placed in a second data region following the first data region, and data of the time during which the operation is executed is placed in a third data region following the second data region.

When it is configured such that the accessory is driven based on such reservation information, a reservation schedule as illustrated in FIG. 6 can be displayed on the side of the external apparatus (center apparatus). Thus, it is possible to set reservation information on the side of the external apparatus (center apparatus), a worker who manages the operation of vehicle 100 can set a work plan (reservation information) after adjusting the work amount, work sharing and time allowance for vehicle 100, and further it is possible to prevent omissions in the work plan, or the like.

Further, on the side of the external apparatus (center apparatus), it is also possible to recognize based on the information transmitted from remote driving state transmitting section 106 whether the reservation schedule has been performed as scheduled. For example, in a case where there is a person in the operation region of the accessory on the date and time of reservation, the activation, the operation, and the termination are not performed as in the reservation schedule, but a worker can recognize the above situation based on the information transmitted from remote driving state transmitting section 106. As a result, when a worker on the side of the external apparatus (center apparatus) determines that the accessory has not operated as in the reservation schedule, the worker is also allowed to set a new reservation schedule.

As described above, according to the present embodiment, the accessory control system includes: vehicle state determining section 101 that determines the state of vehicle 100; vehicle-surrounding-safety monitoring section 102 that monitors safety in the surroundings of vehicle 100; remote instruction receiving section 103 that receives, from an external apparatus, instruction information for operating an accessory; accessory control section 110 that performs control of an operation of the accessory based on a determination result of vehicle state determining section 101, a monitoring result obtained by vehicle-surrounding-safety monitoring section 102, and the instruction information received by remote instruction receiving section 103; and accessory driving section 105 that drives the accessory based on the control by accessory control section 110.

Accordingly, even when the driver does not directly operate the accessory in vehicle 100, the accessory is operated based on the instruction information from the external apparatus, and thus, the burden on the driver can be reduced, and further, the accessory can be controlled even when there is no worker such as the driver, who operates the accessory, on actual site. In addition, since the accessory is controlled not simply based on the instruction information from the external apparatus, but is controlled in consideration of the state of the vehicle and safety in the surroundings of the vehicle as well, the accessory can be safely controlled. Accordingly, it is possible to realize an accessory control system capable of performing automatic control of an accessory safely.

Further, according to the present embodiment, the accessory control system further includes surrounding-notification section 104 that, in response to control of the accessory by accessory control section 110, notifies to the surroundings of vehicle 100 that the accessory operates. Thus, it is possible to call attention such that nobody comes closer to vehicle 100 while the accessory is in operation.

Further, according to the present embodiment, the accessory control system further includes a transmission section (remote driving state transmitting section 106) that transmits information on the control of the accessory by accessory control section 110 to the external apparatus. Thus, it is possible to confirm at the external apparatus whether the accessory has actually operated as in the instruction information.

Any of the embodiment described above is only illustration of an exemplary embodiment for implementing the present invention, and the technical scope of the present invention should not be construed limitedly thereby. That is, the present invention can be implemented in various forms without departing from the spirit or main features thereof.

### INDUSTRIAL APPLICABILITY

The present disclosure may be applied to a specially-equipped vehicle including an accessory, such as, for example, a wing truck, a dump truck, a concrete mixer truck, and a concrete pump truck.

### REFERENCE SIGNS LIST

100 Vehicle
101 Vehicle state determining section
102 Vehicle-surrounding-safety monitoring section
103 Remote instruction receiving section
104 Surrounding-notification section
105 Accessory driving section
106 Remote driving state transmitting section
110 Accessory control section

1. An accessory control system that controls an accessory installed in a vehicle, the accessory control system comprising:
a vehicle state determining section that determines a state of the vehicle;
a vehicle-surrounding-safety monitoring section that monitors safety in surroundings of the vehicle;
a remote instruction receiving section that receives, from an external apparatus, instruction information for operating the accessory;
an accessory control section that performs control of an operation of the accessory based on a determination result of the vehicle state determining section, a monitoring result obtained by the vehicle-surrounding-safety monitoring section, and the instruction information received by the remote instruction receiving section; and
an accessory driving section that drives the accessory based on the control by the accessory control section.

2. The accessory control system according to claim 1, further comprising
a surrounding-notification section that, in response to control of the accessory by the accessory control section, notifies to the surroundings of the vehicle that the accessory operates.

3. The accessory control system according to claim 1, further comprising
a transmission section that transmits information on control of the accessory by the accessory control section to the external apparatus.

4. The accessory control system according to claim 1, wherein
the instruction information includes activation information, operation information, and termination information, the activation information being information for instructing activation of an engine or a motor, the operation information being information for instructing an operation mode of the accessory, the termination information being information for instructing a stop of a power take off (PTO), the engine or the motor, the engine or the motor being a torque-generating source for the PTO.

5. The accessory control system according to claim 1, wherein
the instruction information includes information on a date and a time, the date and the time being a date and a time when the accessory is driven.

6. The accessory control system according to claim 1, wherein
the external apparatus is a center apparatus that transmits the instruction information for controlling a plurality of the vehicles including the accessory to each of the plurality of vehicles, and transmits reservation information including date and time information for operating the accessory to each of the plurality of vehicles.
